(19) United States
(12) Patent Application Publication
(10) Pub. No.: US 2025/0250418 A1
(43) Pub. Date: Aug. 7, 2025

(54) MIXTURE FOR INHIBITING THE EMISSION OF ALDEHYDES FROM POLYURETHANE FOAM FOR AN EXTENDED PERIOD OF TIME

(71) Applicant: Huntsman Petrochemical LLC, The Woodlands, TX (US)

(72) Inventors: Renjie JI, Shanghai (CN); Yide LIANG, Shanghai (CN)

(21) Appl. No.: 18/855,663

(22) PCT Filed: Apr. 5, 2023
(86) PCT No.: PCT/US2023/017509

§ 371 Date: Oct. 10, 2024

Related U.S. Application Data
(60) Provisional application No. 63/330,803, filed on Apr. 14, 2022.

(51) Int. Cl. C08K 5/3462; C08G 18/18; C08G 18/32; C08G 18/48; C08J 9/14; C08K 5/17; C08K 5/3445

(52) U.S. Cl. CPC C08K 5/3462; C08G 18/1833; C08G 18/3275; C08G 18/4804; C08J 9/143; C08K 5/17; C08K 5/3445; C08G 2110/0058; C08G 2110/0083

(57) ABSTRACT

The present disclosure relates to an isocyanate reactive composition for use in a polyurethane formulation and to methods of making polyurethane material from the polyurethane formulation. The isocyanate reactive composition generally includes an aldehyde scavenger blend capable of reducing the emission of aldehydes from the polyurethane material produced from the polyurethane formulation for an extended period of time.

### CROSS-REFERENCE TO RELATED APPLICATION

This application claims priority to U.S. Provisional Patent Application Ser. No. 63/330,803 filed Apr. 14, 2022. The noted application is incorporated herein by reference.

### STATEMENT REGARDING FEDERALLY SPONSORED RESEARCH OR DEVELOPMENT

Not applicable.

### FIELD

The present disclosure generally relates to polyurethane formulations containing an aldehyde scavenger blend, methods for making polyurethane materials using such formulations and the polyurethane materials obtained from such methods exhibiting reduced levels of aldehyde emissions for an extended period of time.

### BACKGROUND

Polyurethane foam is widely known and used in many applications. For example, it is often used as insulation materials in appliances and as cushioning material in bedding and furniture. In automobiles and trucks, polyurethane foam is used as seat cushioning, in headrests, in dashboards and instrument panels, in armrests, in headliners as well as other areas. One drawback to using such foam in these applications is that it can emit organic substances, in particular aldehydes, over time causing unpleasant odors or, in the event of high concentration, health-related problems especially when exposure takes place within enclosed spaces. Aldehyde exposure limits, including limits specifically for formaldehyde and acetaldehyde, have been assigned by various government agencies. These exposure limits are of significant interest to the automobile and slabstock industries in the overall efforts of these industries to enhance the air quality within the automobile's cabin of an and of bedding materials.

Accordingly, various attempts have been made to reduce or lower aldehyde emissions from polyurethane foam. For example, aldehyde scavengers such as CH-acidic compounds (see US 2016/0304686), amine compounds having at least two secondary amine groups (see WO 2014/026802), hydrazine compounds (see US 2006/0141236), polyhydrazodicarbonamide compounds (see US 2013/0203880)\, reducing agents, such as sodium borohydride (see JP 2005154599), cyclic ureas and free radical scavengers (see WO 2016/0200854), and cyanoacetamide (see WO 2015/082316) have all been used in the production of polyurethane foam in an attempt to reduce aldehyde emissions to acceptable industry levels.

While each of the above aldehyde scavengers are capable of reducing aldehyde emissions, there is a continuing need for the development of new aldehyde scavenger systems which are capable of lowering the levels of aldehyde emissions from polyurethane foam more efficiently and for a longer period of time.

### SUMMARY

The present disclosure provides an isocyanate reactive composition comprising an aldehyde scavenger blend, an active hydrogen-containing compound, and a catalyst.

According to another embodiment, the present disclosure provides a polyurethane formulation comprising the isocyanate reactive composition above and a compound containing an isocyanate functional group.

In yet another embodiment there is provided a method of forming a polyurethane foam comprising contacting a compound containing an isocyanate functional group and optional auxiliary components in the presence of the isocyanate reactive composition.

### DETAILED DESCRIPTION

The following terms shall have the following meanings:

The term “comprising” and derivatives thereof are not intended to exclude the presence of any additional component, step, or procedure, whether or not the same is disclosed herein. To avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step, or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e., to at least one) of the grammatical objects of the article. By way of example, “an amine” means one amine or more than one amine. The phrases “in one embodiment”, “according to one embodiment” and the like generally mean the particular feature, structure, or characteristic following the phrase is included in at least one embodiment of the present disclosure and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2% by weight, or less than 1% by weight, or less than 0.5% by weight, or less than 0.1% by weight, or less than 0.05% by weight, or even less than 0.01% by weight based on the total weight of the composition, or that no amount of that particular compound or moiety is present in the respective composition.

The term “extended period of time” refers to a period of time (or time period) that can range from one week up to one year or up to two years; or a period of time ranging from one to two weeks, or two to three weeks, or three to four weeks; or a period of time ranging from one to two months, or two to three months, or three to four months, or three to six months, or six months to 12 months, or 12 months to 24 months; or a period of time in the range of several days, such as 7, 10 or 12 days, or several weeks, such as 2, 3 or 4 weeks, or one month, or several months, such as 2, 3, 4, 5 or six months or even longer, such as 7, 8, 9 or 12 months.

The term “reduced level of emission” or the like refers to a reduced level or amount of emission of a substance, such as an aldehyde, from a material, such as polyurethane foam, compared to a suitable reference level, such as the level or amount of emission of the same aldehyde from a polyurethane foam known to be prepared in the presence of aldehyde scavenges not according to the present disclosure or polyurethane foam known to prepared in the absence of any aldehyde scavengers.

Where substituent groups are specified by their conventional chemical formula, written from left to right, they equally encompass the chemically identical substituents that would result from writing the structure from right to left, for example, —CH₂O— is equivalent to —OCH₂-.

The term “alkyl” refers to straight chain or branched chain saturated hydrocarbon groups having from 1 to 50 carbon atoms or from 1 to 40 carbon atoms, or from 1 to 30 carbon atoms, or from 1 to 20 carbon atoms or from 1 to 10 carbon atoms. In some embodiments, alkyl substituents may be lower alkyl groups. The term “lower” refers to alkyl groups having from 1 to 6 carbon atoms. Examples of “lower alkyl groups” include, but are not limited to, methyl, ethyl, n-propyl, i-propyl, butyl, and pentyl groups.

The term “alkenyl” means a straight or branched alkyl group having one or more double carbon-carbon bonds and 2-20 carbon atoms, including, but not limited to, ethenyl, 1-propenyl, 2-propenyl, 2-methyl-1-propenyl, 1-butenyl, and 2-butenyl. In some embodiments, the alkenyl chain is from 2 to 10 carbon atoms in length, from 2 to 8 carbon atoms in length, from 2 to 6 carbon atoms in length, or from 2 to 4 carbon atoms in length.

The term “alkoxy” means a functional group —OR, where R is an alkyl group as defined above. Non-limiting examples of alkoxy groups are —OCH₃, —OCH₂CH₃, —OCH₂CH₂CH₃, —OCH(CH₃)₂, —OCH(CH₂)₂, —O-cyclopentyl, and —O-cyclohexyl.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylalkyl” refers to a monovalent group that is an alkyl group substituted with an aryl group. The term “alkylaryl” refers to a monovalent group that is an aryl group substituted with an alkyl group. Unless otherwise indicated, for both, the alkyl portion often has 1 to 10 carbon atoms, 1 to 6 carbon atoms, or 1 to 4 carbon atoms and the aryl portion often has 6 to 20 carbon atoms, 6 to 18 carbon atoms, 6 to 16 carbon atoms, 6 to 12 carbon atoms, or 6 to 10 carbon atoms.

The term “cycloalkyl” refers to a cyclized C₃-C₃₀, suitably C₃-C₂₀ alkyl group.

The term “halogenated olefin” refers to an olefin compound or moiety which may include fluorine, chlorine, bromine, or iodine.

The term “optional” or “optionally” means that the subsequently described event or circumstance may or may not occur, and that the description includes instances where said event or circumstance occurs and instances where it does not.

The present disclosure is generally directed to an isocyanate reactive composition comprising an aldehyde scavenger blend and an active hydrogen-containing compound and its use in polyurethane formulations. The present disclosure is also directed to rigid or flexible polyurethane foam or other polyurethane materials made from a polyurethane formulation comprising the isocyanate reactive composition as described herein and a compound containing an isocyanate functional group. The term “polyurethane” as used herein, is understood to encompass pure polyurethane, polyurethane polyurea and pure polyurea. It has been surprisingly found the aldehyde scavenger blend of the present disclosure (when used in a process of producing a polyurethane foam by reacting an isocyanate reactive composition comprising the aldehyde scavenger blend, with a compound containing an isocyanate functional group) may significantly lower the emission of aldehydes (such as formaldehyde, acetaldehyde and propionaldehyde), and optionally also dimethylformamide (DMF) from the polyurethane foam for an extended period of time without adversely affecting the mechanical properties of the resulting foam or the appearance of the isocyanate reactive composition during storage.

According to one embodiment, the isocyanate reactive composition includes: (A) an aldehyde scavenger blend comprising: (i) a cyclic urea substituted with at least one isocyanate reactive group; (ii) a compound of the formula (I)

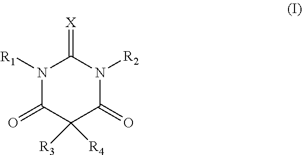

where X is O, S, or NHR₅ and R₁, R₂, R₃, R₄ and R₅ are individually selected from hydrogen, or an unsubstituted or substituted alkyl, alkenyl, aryl, alkylaryl, or alkoxy group subject to the proviso that at least one of R₃ and R₄ is hydrogen; and (iii) an amine compound selected from ammonia, a primary amine, and a mixture thereof, (B) an active hydrogen-containing compound, and (C) a catalyst.

As noted above, the aldehyde scavenger blend includes a cyclic urea substituted with at least one isocyanate reactive group. The cyclic urea substituted with at least one isocyanate reactive group may be a cycloaliphatic or bicycloaliphatic compound having an element of the structure —NH-CO-NH- within a ring structure. In one embodiment, the cyclic urea has a total number of ring atoms ranging from 5 to 7. Such cyclic urea is substituted with at least one isocyanate reactive group on either the —N or —C atoms or both.

In one particular embodiment, the cyclic urea substituted with at least one isocyanate reactive group is a compound having the formula (II)

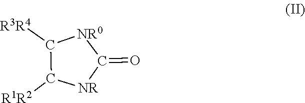

where R, R⁰, R¹, R², R³, and R⁴ are independently -H, —OH, -R⁵OH, —NH or —COOH, and R⁵ is a C₁-C₄ alkyl group, with the proviso that at least one of R or R⁰ is —H, and further with the proviso that: at least one of R, R⁰, R¹, R², R³, and R⁴ is —OH, —COOH, -R⁵OH, or —NH; or R¹R² or R³R⁴ are NH₂.

Examples of such compounds of formula (II) include, but are not limited to, 4,5-dihydroxy-2-imidazolidinone, 4,5-dimethoxy-2-imidazolidinone, 4-hydroxyethyl ethylene urea, 4-hydroxy-5-methyl propylene urea, 4-methoxy-5-methyl propylene urea, 4-hydroxy-5,5-dimethyl propylene urea, and 1-(2-hydroxyethyl)-2-imidazolidinone.

In another embodiment, the cyclic urea substituted with at least one isocyanate group may be compound having the formula (III)

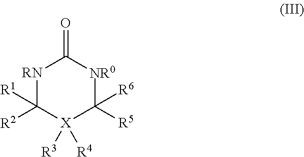

where R, R⁰, R¹, R², R⁵ and R⁶ are independently —H, —OH, -R⁷OH, —NH or —COOH, R³ and R⁴ are individually not present, —H, —OH, -R⁷OH, —NH or —COOH, R⁷ is a C₁-C₄ alkyl group X is C, O or N with the proviso that when X is O, R³ and R⁴ are each not present and when X is N, one of R³ or R⁴ is not present, and further with the proviso at least one of R or R⁰ is —H and that at least: one of R⁰, R¹, R², R³, R⁴, R⁵, R⁶is —OH, —COOH, -R⁷OH, or —NH; or R¹R² or R⁵R⁶ are NH₂.

Examples of such compounds of formula (III) include, but are not limited to, tetrahydro-5-(2-hydroxyethyl)-1,3,5-triazin-2-one, tetrahydro-5-(ethyl)-1,3,5-triazin-2-one, tetrahydro-5-(propyl)-1,3,5-triazin-2-one, tetrahydro-5-(butyl)-1,3,5-triazin-2-one, or mixtures thereof.

In one embodiment, the amount of the cyclic urea substituted with at least one isocyanate reactive group present may be at least about 10% by weight, or at least about 20% by weight, or at least about 30% by weight, or at least about 40% by weight, or at least about 50% by weight, or at least about 60% by weight, or at least about 70% by weight, or at least about 80% by weight, or at least about 90% by weight, based on the total weight of the aldehyde scavenger blend. In another embodiment, the amount of the cyclic urea substituted with at least one isocyanate reactive group present may be between about 5-95% by weight, or between about 10-90% by weight, or between about 20-80% by weight, or between about 30-70% by weight, or between about 40-60% by weight, based on the total weight of the aldehyde scavenger blend.

The aldehyde scavenger blend also includes a compound of formula (I)

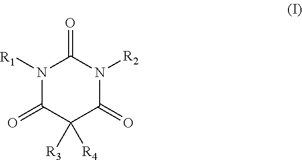

where X is O, S, or NHR₅ and R₁, R₂, R₃, R₄ and R₅ are individually —H, or an unsubstituted or substituted alkyl, alkenyl, cycloalkyl, aryl, alkylaryl, or alkoxy group subject to the proviso that at least one of R₃ and R₄ is —H.

According to one embodiment, X is O, S, or NHR₅ and R₁, R₂, R₃, R₄ and R₅ may be identical or different and are —H, a C₁-C₁₈ alkyl group, a C₂-C₁₈ alkenyl group, a C₃-C₁₀ cycloalkyl group, a C₇-C₁₈ alkylaryl group, an alkoxy group or a C₆-C₁₈ aryl group subject to the proviso that at least one of R₃ and R₄ is —H.

If one of the radicals R₁ to R₄ is a C₁-C₁₈ alkyl group then this radical can be straight-chain or branched and can contain, for example, from 1 to 10 carbon atoms or from 1 to 6 carbon atoms. Examples of alkyl groups are methyl, ethyl, propyl, isopropyl, n-butyl, t-butyl, isobutyl, n-pentyl, and isoamyl.

If one of the radicals R₁ to R₄ is an alkoxyl group, then the alkoxy radical contains, for example, a C₁-C₅ alkyl group, such as methyl, ethyl, propyl, isopropyl, n-butyl, t-butyl, isobutyl, n-pentyl or isoamyl.

If one of the radicals R₁ to R₄ is a C₂-C₁₈ alkenyl group, then preference is given to C₂ to C₅ alkenyl radicals.

If one of the radicals R₁ to R₄ is a C_{c}-C₁₀ cycloalkyl group then preference is given to C₄-C₇ cycloalkyl radicals, such as cyclopentyl and cyclohexyl.

If one of the radicals R₁ to R₄ is C₆-C₁₈ aryl group then preference is given to phenyl and naphthyl.

Examples of compounds of the formula (I) include barbituric acid, thiobarbituric acid, 1,3,5-trimethylbarbituric acid, 1-phenyl-5-benzylbarbituric acid, 1-benzyl-5-phenylbarbituric acid, 1,3-dimethylbarbituric acid, 1,3-dimethyl-5-phenylbarbituric acid, 1-cyclohexyl-5-ethylbarbituric acid, 5-laurylbarbituric acid, 5-butylbarbituric acid, 5-allylbarbituric acid, 5-hydroxy-5-butylbarbituric acid, 5-phenylthiobarbituric acid, 1,3-dimethylthiobarbituric acid, 5,5-dibromobarbituric acid, trichlorobarbituric acid, 5-nitrobarbituric acid, 5-aminobarbituric acid, 5-hydroxybarbituric acid and 5,5-dihydroxybarbituric acid.

In one embodiment, the amount of the compound of formula (I) present may be less than about 90% by weight, or less than about 80% by weight, or less than about 70% by weight, or less than about 60% by weight, or at less than about 50% by weight, or less than about 40% by weight, or less than about 30% by weight, or less than about 20% by weight, or less than about 10% by weight, based on the total weight of the aldehyde scavenger blend. In another embodiment, the amount of the compound of formula (I) present may be between about 0.5-90% by weight, or between about 1-75% by weight, or between about 1.5-50% by weight, or between about 2-30% by weight, or between about 3-20% by weight, based on the total weight of the aldehyde scavenger blend.

The aldehyde scavenger blend also includes an amine compound selected from ammonia, a primary amine, and a mixture thereof. In one embodiment, the primary amine is a compound having the formula (IV)

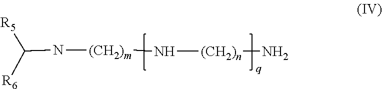

where R₅ and R₆ are individually selected from hydrogen, or an unsubstituted or substituted alkyl, alkenyl, aryl, alkylaryl, or alkoxy group, m is 2 or 3, n is 2, and q is 0-3.

In embodiments of the present disclosure, the primary amine may be, but is not limited to: tetra-ethylene-pentamine (TEPA), dimethyl-amino-propylamine (DMAPA), triethylene tetraamine (TETA), pentaethylene hexaamine (PEELA), hexaethylene heptamine (HEHA), heptaethylene octamine (HEOA), octaethylene nonamine (OENO); polyetheramine products from Huntsman Corporation such as compounds having a formula (V)

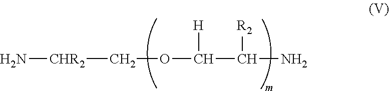

where m is an integer of 2 to about 100 and each R₂ is independently hydrogen, methyl, or ethyl; or (VI)

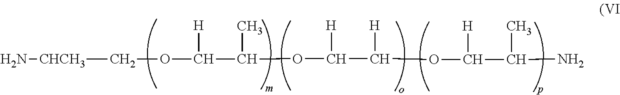

where n and p are each independently integers from about 1 to about 10 and o is an integer from about 2 to about 40; or (VII)

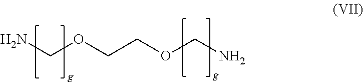

where g is 2 or 3 and can include Jeffamine®D230 amine, Jeffamine®D400 amine, Jeffamine®D2000 amine, Jeffamine®EDR148 amine, Jeffamine®EDR176 amine, Jeffamine®ED600 amine, Jeffamine®EDR900 amine, and Jeffamine®ED2003 amine; amines obtained by adducting polyether amine or polyethylene amine with urea or a guanidine compound, such as the amine obtained by reacting guanidine with TETA; and amines obtained from the Michael Addition reaction of an alcohol-containing or amino-containing tertiary amine followed by hydrogenation, such as the amine obtained by reacting DMAPA with acrylonitrile followed by hydrogenation, and the amine obtained by reacting DMEA (dimethylaminoethanol) with acrylonitrile followed by hydrogenation.

In one embodiment, the amount of the amine present may be less than about 90% by weight, or less than about 80% by weight, or less than about 70% by weight, or less than about 60% by weight, or at less than about 50% by weight, or less than about 40% by weight, or less than about 30% by weight, or less than about 20% by weight, or less than about 10% by weight, based on the total weight of the aldehyde scavenger blend. In another embodiment, the amount of the amine present may be between about 0.5-90% by weight, or between about 1-75% by weight, or between about 1.5-50% by weight, or between about 2-30% by weight, or between about 3-20% by weight, based on the total weight of the aldehyde scavenger blend.

In some embodiments, the amount of the aldehyde scavenger blend present may be less than about 2.5% by weight, or less than about 2% by weight, or less than about 1.5% by weight, or less than about 1% by weight, or less than about 0.5% by weight, based on the total weight of the isocyanate reactive composition, In other embodiments, the amount of aldehyde scavenger blend present may between about 0.01-3% by weight, or between about 0.05-1.0% by weight, or between about 0.05-0.5% by weight, based on the total weight of the isocyanate reactive composition. The amount of aldehyde scavenger blend may vary depending on the type of polyurethane that is made and the compound containing an isocyanate group and the active hydrogen-containing compound that are used. Preferably the amount of the aldehyde scavenger blend present is an effective amount that is capable of reducing the emission of one or more of acetaldehyde, formaldehyde and propionaldehyde.

The isocyanate reactive composition also includes an active hydrogen-containing compound comprising a polyol, a polyfunctional amine or a mixture thereof.

In one embodiment, the active hydrogen-containing compound is a polyol. Polyols suitable for use in the present disclosure include, but are not limited to, polyalkylene ether polyols, polyester polyols, biorenewable polyols, polymer polyols, a non-flammable polyol such as a phosphorus-containing polyol or a halogen-containing polyol. Such polyols may be used alone or in suitable combination as a mixture. General functionality of the polyols used in the present disclosure may be from 2 to 6. The molecular weight of the polyols may be in an amount ranging from about 200-10,000 Daltons, preferably from about 400-7,000 Daltons where the molecular weight is the weight average molecular weight defined by the Gel Permeation Chromatography (GPC) method with polystyrene as a reference.

Polyalkylene ether polyols include poly(alkylene oxide) polymers such as poly(ethylene oxide) and polypropylene oxide) polymers and copolymers with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols include, but are not limited to, those produced by reacting a dicarboxylic acid with an excess of a diol, for example, adipic acid with ethylene glycol or butanediol, or reaction of a lactone with an excess of a diol such as caprolactone with propylene glycol.

In addition to polyalkylene ether polyols and polyester polyols, polymer polyols are also suitable for use in the present disclosure. Polymer polyols are used in polyurethane materials to increase resistance to deformation, for example, to improve the load-bearing properties of the foam or material. Examples of polymer polyols include, but are not limited to, graft polyols or polyurea modified polyols (Polyharnstoff Dispersion polyols). Graft polyols comprise a triol in which vinyl monomers are graft copolymerized. Suitable vinyl monomers include, for example, styrene, or acrylonitrile. A polyurea modified polyol is a polyol containing a polyurea dispersion formed by the reaction of a diamine and a diisocyanate in the presence of a polyol. A variant of polyurea modified polyols are polyisocyanate poly addition (PIPA) polyols, which are formed by the in-situ reaction of an isocyanate and an alkanolamine in a polyol.

Biorenewable polyols suitable for use in the present disclosure include castor oil, sunflower oil, palm kernel oil, palm oil, canola oil, rapeseed oil, soybean oil, com oil, peanut oil, olive oil, algae oil, and mixtures thereof.

The non-flammable polyol may, for example, be a phosphorus-containing polyol obtainable by adding an alkylene oxide to a phosphoric acid compound. Halogen-containing polyols may, for example, be those obtained by ring-opening polymerization of epichlorohydrin or trichlorobutylene.

In another embodiment, the active hydrogen-containing compound is a polyfunctional polyamine, such as a polyetheramine, a polyester polyamine or a mixture thereof.

In one particular embodiment, the polyetheramine may be a polyetheramine described above (i.e., having the formula (V)-(VII)). For example, the polyetheramine may be a compound having the formula (V) where each R₂ is independently hydrogen or methyl and m is an integer of 2 to about 70, or 2 to about 35 or 2 to about 7. In other embodiments, each R₂ is independently hydrogen or methyl and m is an integer of 6 to about 70 or about 6 to about 35. In still further embodiments, each R₂ is methyl and m is an integer of 2 to about 70.

In another embodiment, the polyetheramine may a compound having the formula (VI) where o is an integer of about 2 to about 40, or about 2 to about 13 or about 2 to about 10. In another embodiment, o is an integer of about 9 to about 40, or about 12 to about 40 or about 15 to about 40, or even about 25 to about 40. In other embodiments, n+p is an integer within a range of about 1 to about 6, or within a range of about 1 to about 4 or within a range of about 1 to about 3. In further embodiments, n+p is an integer within a range of about 2 to about 6 or within a range of about 3 to about 6.

In another embodiment, the polyetheramine may be a compound having a formula (VIII)

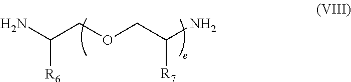

where each R₆ and R₇ independently are hydrogen, methyl, or ethyl and e, is an integer from 1 to 10; or formula (IX)

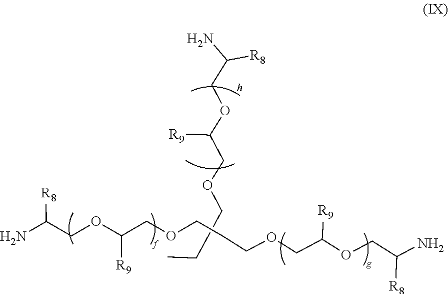

where each R₈ and R₉ are independently hydrogen, methyl, or ethyl and f, g and h are an integer from 1 to 8.

In still other embodiments, the polyfunctional amine may be a polyester polyamine. Examples of polyester polyamines include polyesters with two terminal amine groups prepared from polyesters such as poly(ethylene glutarate), poly(ethylene adipate), poly(ethylene azelate), poly(trimethylene glutarate), poly(tetramethylene glutarate), poly(pentamethylene glutarate), poly(diethylene glutarate), poly(diethylene adipate), poly(triethylene adipate), and poly(1,2-propylene adipate).

The amount of active hydrogen-containing compound present in the isocyanate reactive composition may be at least about 40% by weight, or at least about 50% by weight, or at least about 60% by weight, or at least about 70% by weight, or at least about 80% by weight, or at least about 90% by weight, or at least about 95% by weight, based on the total weight of the isocyanate reactive composition.

The isocyanate reactive composition also includes a catalyst. In one embodiment, the catalyst is an amine catalyst. The amine catalyst of the present disclosure may be any amine useful as a catalyst in a polyurethane foam or material formation reaction. According to one embodiment, the amine catalyst is an amine containing one or more tertiary amino groups. Examples include, but are not limited to, bis-(2-dimethylaminoethyl) ether (JEFFCAT® ZF-20 catalyst), N,N,N′-trimethyl-N′-hydroxyethylbisaminoethylether (JEFFCAT® ZF-10 catalyst), N-(3-dimethylaminopropyl)-N, N-diisopropanolamine (JEFFCAT® DPA catalyst), N, N-dimethylethanolamine (JEFFCAT® DMEA catalyst), triethylene diamine (JEFFCAT® TEDA catalyst), blends of N,N-dimethylethanolamine and triethylene diamine (such as JEFFCAT®TD-20 catalyst), N,N-dimethylcyclohexylamine (JEFFCAT® DMCHA catalyst), benzyldimethylamine (JEFFCAT® BDMA catalyst), pentamethyldiethylenetriamine (JEFFCAT® PMDETA catalyst), N,N,N′,N″,N″-pentamethyldipropylenetriamine (JEFFCAT® ZR-40 catalyst), N,N-bis(3-dimethylaminopropyl)-N-isopropanolamine (JEFFCAT® ZR-50 catalyst), N′-(3-(dimethylamino)propyl-N,N-dimethyl-1,3-propanediamine (JEFFCAT® Z-130 catalyst), 2-(2-dimethylaminoethoxy)ethanol (JEFFCAT® ZR-70 catalyst), N,N,N′-trimethylaminoethyl-ethanolamine (JEFFCAT® Z-110 catalyst), N-ethylmorpholine (JEFFCAT® NEM catalyst), N-methylmorpholine (JEFFCAT® NMM catalyst), 4-methoxyethylmorpholine, N,N′dimethylpiperzine (JEFFCAT® DMP catalyst), 2,2′dimorpholinodiethylether (JEFFCAT® DMDEE catalyst), 1,3,5-tris(3-(dimethylamino)propyl)-hexahydro-s-triazine (JEFFCAT® TR-90 catalyst), 1-Propanamine, 3-(2-(dimethylamino)ethoxy), substituted imidazoles such as 1,2-dimethlyimidazol and 1-methyl-2-hydroxyethylimidazole, N,N′-dimethylpiperazines or bis-substituted piperazines such aminoethylpiperazine, N,N′,N′-trimethyl aminoethylpiperazine or bis-(N-methyl piperazine)urea, N-methylpyrrolidines and substituted methylpyrrolidines such as 2-aminoethyl-N-methylpyrrolidine or bis-(N-methylpyrrolidine)ethyl urea, 3-dimethylaminopropylamine, N,N,N″,N″-tetramethyldipropylenetriamine, tetramethylguanidine, 1,2 bis-diisopropanol. Other examples of amine catalysts include N-alkylmorpholines such as N-methylmorpholine, N-ethylmorpholine, N-butylmorpholine and dimorpholinodiethylether, N,N′-dimethylaminoethanol, N, N-dimethylamino ethoxyethanol, bis-(dimethylaminopropyl)-amino-2-propanol, bis-(dimethylamino)-2-propanol, bis-(N,N-dimethylamino)ethylether; N,N,N′-trimethyl-N′hydroxyethyl-bis-(aminoethyl)ether, N,N-dimethylaminoethyl-N′-methyl amino ethanol, tetramethyliminobispropylamine and combinations thereof.

According to another embodiment, the catalyst above may be combined with a non-amine catalyst in forming the polyurethane foam or material. Examples of such additional non-amine catalysts include, for example:
tertiary phosphines, such as trialkylphosphines and dialkylbenzylphosphines;
chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co, and Ni;
metal carboxylates such as potassium acetate and sodium acetate;
acidic metal salts of strong acids, such as ferric chloride, stannic chloride, stannous chloride, antimony trichloride, bismuth nitrate and bismuth chloride;
strong bases, such as alkali and alkaline earth metal hydroxides, alkoxides and phenoxides;
alcoholates and phenolates of various metals, such as Ti(OR⁶)₄, Sn(OR⁶)₄ and Al(OR⁶)₃ where R⁶ is alkyl or aryl, and the reaction products of the alcoholates with carboxylic acids, and beta-diketones; and
alkaline earth metal, Bi, Pb, Sn or Al carboxylate salts; and tetravalent tin compounds, and tri-or pentavalent bismuth, antimony, or arsenic compounds.

The catalyst may be used in a catalytically effective amount to catalyze the reaction between a compound containing an isocyanate functional group and an active hydrogen-containing compound for the purpose of making the rigid or flexible polyurethane foam or other polyurethane materials. A catalytically effective amount of the catalyst may range from about 0.01-15 parts per 100 parts of active hydrogen-containing compound, or in some embodiments from about 0.05-12.5 parts per 100 parts of active hydrogen-containing compound, and in even further embodiments from about 0.1-7.5 parts per 100 parts of active hydrogen-containing compound, and yet in even further embodiments from about 0.5-5 parts per 100 parts of active hydrogen-containing compound.

According to another embodiment, the isocyanate reactive composition may optionally include a blowing agent. In one embodiment, the blowing agent may be a halogenated olefin compound. The halogenated olefin compound may comprise at least one haloalkene (for e.g., fluoroalkene or chlorofluoroalkene) comprising from 3 to 4 carbon atoms and at least one carbon-carbon double bond. Suitable compounds may include hydrohaloolefins such as trifluoropropenes, tetrafluoropropenes (e.g., tetrafluoropropene (1234)), pentafluoropropenes (e.g., pentafluoropropene (1225)), chlorotrifloropropenes (e.g., chlorotrifloropropene (1233)), chlorodifluoropropenes, chlorotrifluoropropenes, chlorotetrafluoropropenes, hexafluorobutenes (e.g., hexafluorobutene (1336)), or combinations thereof. In certain embodiments, the tetrafluoropropene, pentafluoropropene, and/or chlorotrifloropropene compounds have no more than one fluorine or chlorine substituent connected to the terminal carbon atom of the unsaturated carbon chain (e.g., 1,3,3,3-tetrafluoropropene (1234ze); 1,1,3,3-tetrafluoropropene, 1,2,3,3,3-pentafluoropropene (1225ye), 1,1,1-trifluoropropene, 1,2,3,3,3-pentafluoropropene, 1,1,1,3,3-pentafluoropropene (1225zc), 1,1,2,3,3-pentafluoropropene (1225yc), (Z)-1,1, 1,2,3-pentafluoropropene (1225yez), 1-chloro-3,3,3-trifluoropropene (1233zd), 1,1,1, 4,4,4-hexafluorobut-2-ene (1336mzzm), or combinations thereof).

According to one embodiment, the halogenated olefin blowing agent may be a compound having the formula:

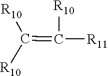

where each R₁₀ is independently Cl, F, H or CF₃, provided that the total number of carbon atoms is either 3 or 4;
R₁₁ is (C(R₁₀)₂)ₘY;
Y is CF₃; and
m is 0 or 1. In one embodiment Y is CF₃ and at least two unsaturated carbons have a chlorine substituent.

Examples of such compounds include, 1,1,1,4, 4.4-hexafluoro-2-butene (1336), 1-chloro-3,3,3-trifluoropropene (1233zd), and 1,3,3,3-tetrafluoropropene (1234ze). In certain highly preferred aspects of such embodiments the 1-chloro-3,3,3-trifluoropropene (1233zd) is trans-1-chloro-3,3,3-trifluoropropene (1233zd(E)), the 1,3,3,3-tetrafluoropropene (1234ze) is trans-1,3,3,3-tetrafluoropropene (1234ze(E)), and the 1,1,14.4.4-hexafluoro-2-butene (1336) is cis-1,1,1,4,4,4-hexafluoro-2-butene (1336(Z)).

According to another embodiment, the halogenated olefin blowing may be a compound having the formula

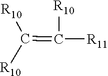

where each R₁₀ is independently Cl, F or H;
R₁₁ is (C(R₁₀)₂)ₙY;
Y is CF₃; and
n is 0 or 1.

Examples of such compounds include 1-chloro-3,3,3-trifluoropropene (1233zd) (preferably trans-1233zd), 2,3,3,3-tetrafluoropropene (1234yf) and 1,3,3,3-tetrafluoropropene (1234ze) (preferably trans-1234ze). In certain of such embodiments, the 1-chloro-3,3,3-trifluoropropene (1233zd) is trans 1-chloro-3,3,3-trifluoropropene (1233zd(E)), the 1,3,3,3-tetrafluoropropene (1234ze) is trans 1,3,3,3-tetrafluoropropene (1234ze(E)), and the 1,1, 14.4.4-hexafluoro-2-butene (1336) is cis 1,1,14.4.4-hexafluoro-2-butene (1336(Z)).

In another embodiment, the blowing agent may be a non-halogenated compound including, but not limited to, water, air, nitrogen, carbon dioxide, hydrofluorocarbons (“HFCs”), alkanes, alkenes, mono-carboxylic acid salts, ketones, ethers, or combinations thereof. Suitable HFCs include 1,1-difluoroethane (HFC-152a), 1,1,1,2-tetrafluoroethane (HFC-134a), pentafluoroethane (HFC-125), 1,1,1,3,3-pentafluoropropane (HFC-245fa), 1,1,1,3,3-pentaflurobutane (HFC-365mfc) or combinations thereof. Suitable alkanes and alkenes include n-butane, n-pentane, isopentane, cyclopentane, 1-pentene, or combinations thereof. Suitable mono-carboxylic acid salts include methyl formate, ethyl formate, methyl acetate, or combinations thereof. Suitable ketones and ethers include acetone, dimethyl ether, or combinations thereof.

The amount of blowing agent may vary widely depending on many factors including the type of foam being made using the blowing agent. According to some embodiments, the amount of blowing agent present may be from about 0.5-40% by weight or from about 1-30% by weight, or from about 2-25% by weight, or from about 3-20% by weight, based on the total weight of the isocyanate reactive composition.

In still another embodiment, the isocyanate reactive composition above may be combined with a compound containing an isocyanate functional group and optional auxiliary components to produce a polyurethane formulation.

According to one embodiment, the compound containing an isocyanate functional group is a polyisocyanate, an isocyanate-terminated prepolymer or a mixture thereof.

Polyisocyanates include those represented by the general formula Q(NCO)_{d} where d is a number from 2-5, such as 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms.

Examples of polyisocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3-and 1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI, or HMDI); 1,3-and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MIDI); norbornane diisocyanates; m- and p-isocyanatophenyl sulfonylisocyanates; perchlorinated aryl polyisocyanates; modified polyisocyanates containing carbodiimide groups, urethane groups, allophnate groups, isocyanurate groups, urea groups, or biruret groups; polyisocyanates obtained by telomerization reactions; polyisocyanates containing ester groups; and polyisocyanates containing polymeric fatty acid groups. Those skilled in the art will recognize that it is also possible to use mixtures of the polyisocyanates described above.

Isocyanate-terminated prepolymers may also be employed in the preparation of the polyurethane. Isocyanate-terminated prepolymers may be prepared by reacting an excess of polyisocyanate or mixture thereof with a minor amount of an active-hydrogen containing compound described above as determined by the well-known Zerewitinoff test.

The amount of the compound containing an isocyanate functional group present in the polyurethane formulation is not limited, but it will typically be within those NCOI index ranges known to those skilled in the art, such as an NCO index between about 70-150 or between about 80-130, or between about 90-115. As is known in the art, the NCO index is defined as the number of equivalents of isocyanate, divided by the total number of equivalents of active hydrogen, multiplied by 100 and can be represented by the following formula

$$NCO index = [ NCO / ( OH + NH ) ] * 100$$

In addition, the polyurethane formulation may optionally include one or more auxiliary components. Examples of auxiliary components include, but are not limited to, cell stabilizers, crosslinking agents, chain extenders, pigments, fillers, flame retardants, thermally expandable microspheres, thickening agents, smoke suppressants, reinforcements, antioxidants, UV stabilizers, antistatic agents, infrared radiation absorbers, dyes, mold release agents, antifungal agents, biocides, or any combination thereof.

Cell stabilizers may include, for example, silicone surfactants as well as organic anionic, cationic, zwiterionic or nonionic surfactants. Examples of suitable silicone surfactants include, but are not limited to, polyalkylsiloxanes, polyoxyalkylene polyol-modified dimethylpolysiloxanes, alkylene glycol-modified dimethylpolysiloxanes, or any combination thereof. Suitable anionic surfactants include, but are not limited to, salts of fatty acids, salts of sulfuric acid esters, salts of phosphoric acid esters, salts of sulfonic acids, and combinations of any of these. Suitable cationic surfactants include but are not limited to quaternary ammonium salts (pH dependent or permanently charged) such as cetyl trimethylammonium chloride, cetyl pyridinium chloride, polyethoxylated tallow amine, benzalkonium chloride, benzethonium chloride and the like. Suitable zwiterionic or amphoteric surfactants include but are not limited to sultaines, amino acids, imino acids, betaines, and phosphates. Suitable non-ionic surfactants include but are not limited to fatty alcohols, polyoxyethylene glycol alkyl ethers, polyoxypropylene glycol alkyl ethers, glucosides (such as decyl, lauryl and octyl glucosides), polyoxyethylene glycol alkyl phenol ethers, and glycol alkyl esters. Suitable predetermined amounts for all cell stabilizers include, but are not limited to, about 0-20 parts by weight per 100 parts by weight of the active hydrogen-containing compound, or about 0.15-10 parts by weight per 100 parts by weight of the active hydrogen-containing compound, or about 0.2-5 parts by weight per 100 parts by weight of the active hydrogen-containing compound.

Examples of crosslinking agents include, but are not limited to, low-molecular weight compounds containing at least two moieties selected from hydroxyl groups, primary amino groups, secondary amino groups, and other active hydrogen-containing groups which are reactive with an isocyanate group. Crosslinking agents include, for example, polyhydric alcohols (especially trihydric alcohols, such as glycerol and trimethylolpropane), polyamines, and combinations thereof. Non-limiting examples of polyamine crosslinking agents include diethyltoluenediamine, chlorodiaminobenzene, diethanolamine, diisopropanolamine, triethanolamine, tripropanolamine, 1,6-hexanediamine, and combinations thereof. Typical diamine crosslinking agents comprise twelve carbon atoms or fewer, more commonly seven or fewer.

Examples of chain extenders include, but are not limited to, compounds having hydroxyl or amino functional group, such as glycols, amines, diols, and water. Specific non-limiting examples of chain extenders include ethylene glycol, diethylene glycol, propylene glycol, dipropylene glycol, 1,4-butanediol, 1,3-butanediol, 1,5-pentanediol, neopentyl glycol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, or any mixture thereof. In some embodiments, the amount of crosslinking agent/chain extender present may be from about 0-5 parts by weight per 100 parts by weight of the active hydrogen-containing compound, preferably about 0.4-3.5 parts by weight per 100 parts by weight of the active hydrogen-containing compound.

Pigments may be used to color code the polyurethane materials during manufacture, to identify product grade, or to conceal yellowing. Pigments may include any suitable organic or inorganic pigments. For example, organic pigments or colorants include, but are not limited to, azo/diazo dyes, phthalocyanines, dioxazines, or carbon black. Examples of inorganic pigments include, but are not limited to, titanium dioxide, iron oxides or chromium oxides. In some embodiments, the amount of pigment present may be from about 0-10 parts by weight per 100 parts by weight of the active hydrogen-containing compound, preferably about 0.1-5 parts by weight per 100 parts by weight of the active hydrogen-containing compound.

Fillers may be used to increase the density and load bearing properties of polyurethane foam or material. Suitable fillers include, but are not limited to, barium sulfate, carbon black or calcium carbonate. In some embodiments, the amount of filler present may be from about 0-20 parts by weight per 100 parts by weight of the active hydrogen-containing compound, preferably about 0.1-10 parts by weight per 100 parts by weight of the active hydrogen-containing compound.

Flame retardants can be used to reduce flammability. For example, such flame retardants include, but are not limited to, chlorinated phosphate esters, chlorinated paraffins or melamine powders. In some embodiments, the amount of flame retardant present may be from about 0-20 parts by weight per 100 parts by weight of the active hydrogen-containing compound, preferably about 0.1-10 parts by weight per 100 parts by weight of the active hydrogen-containing compound.

Thermally expandable microspheres include those containing a (cyclo)aliphatic hydrocarbon. Such microspheres are generally dry, unexpanded, or partially unexpanded microspheres consisting of small spherical particles with an average diameter of typically 10 to 15 microns. The sphere is formed of a gas proof polymeric shell (e.g., consisting of acrylonitrile or PVDC), encapsulating a minute drop of a (cyclo)aliphatic hydrocarbon, e.g., liquid isobutane. When these microspheres are subjected to heat at an elevated temperature level (e.g., 150° C. to 200° C.) sufficient to soften the thermoplastic shell and to volatilize the (cyclo)aliphatic hydrocarbon encapsulated therein, the resultant gas expands the shell and increases the volume of the microspheres. When expanded, the microspheres have a diameter 3.5 to 4 times their original diameter as a consequence of which their expanded volume is about 50 to 60 times greater than their initial volume in the unexpanded state. Examples of such microspheres are the EXPANCEL®-DU microspheres which are marketed by AKZO Nobel Industries of Sweden.

Various types of polyurethane materials can be made from the polyurethane formulation according to the present disclosure, such as rigid foams, flexible foams, semi-flexible foams, microcellular elastomers, backings for textiles, spray elastomers, cast elastomers, polyurethane-isocyanurate foams, reaction injection molded polymers, structural reaction injection molded polymers and the like.

A non-limiting example of a general flexible polyurethane foam formulation having a 15-150 kg/m³ density (e.g., automotive seating) may comprise the following components in parts by weight (pbw):

| Flexible Foam Formulation | pbw |
|---|---|
| Polyol | 20-100 |
| Aldehyde Scavenger Blend | 0.1-1.5 |
| Cell Stabilizer | 0.3-3 |
| Blowing Agent | 0.5-6 |
| Crosslinker | 0.1-3 |
| Catalyst | 0.2-2.5 |
| Isocyanate Index | 70-115 |

A non-limiting example of a general rigid polyurethane foam formulation having a 15-70 kg/m³ density may comprise the following components in parts by weight (pbw):

| Rigid Foam Formulation | Pbw |
|---|---|
| Polyol | 100 |
| Aldehyde Scavenger Blend | 0.1-2 |
| Cell Stabilizer | 1-3 |
| Blowing Agent | 8-15 |
| Water | 0-3 |
| Catalyst | 0.5-3 |
| Isocyanate Index | 80-400 |

Thus, in yet another embodiment, the present disclosure provides a method for producing a polyurethane material which comprises contacting the compound containing an isocyanate functional group, the isocyanate reactive composition according to the present disclosure, and optional auxiliary components.

In one particular embodiment, the polyurethane material is a rigid or flexible foam prepared by bringing together the isocyanate reactive composition comprising at least one active hydrogen-containing compound, such as a polyol, the aldehyde scavenger blend, the catalyst, the optional blowing agent and auxiliaries and a compound containing an isocyanate functional group to form a reaction mixture and subjecting the reaction mixture to conditions sufficient to cause the active hydrogen-containing compound to react with the compound containing an isocyanate functional group. The isocyanate reactive composition and compound containing an isocyanate functional group may be heated prior to mixing them and forming the reaction mixture. In other embodiments, the isocyanate reactive composition and compound containing an isocyanate functional group are mixed at ambient temperature (for e.g., from about 15°-40° C.) and heat may be applied to the reaction mixture, but in some embodiments, applying heat may not be necessary. The polyurethane foam may be made in a free rise (slabstock) process in which the foam is free to rise under minimal or no vertical constraints. Alternatively, molded foam may be made by introducing the reaction mixture in a closed mold and allowing it to foam within the mold. The particular active hydrogen-containing compound and compound containing an isocyanate functional group are selected with the desired characteristics of the resulting foam. The blowing agent and other auxiliary components useful in making polyurethane foams, such as those described above, may also be included to produce a particular type of foam.

According to another embodiment, a polyurethane material may be produced in a one-step process in which an A-side reactant (a compound containing an isocyanate functional group) is reacted with a B-side reactant (isocyanate reactive composition). The compound containing an isocyanate functional group may comprise a polyisocyanate while the isocyanate reactive composition may comprise an active-hydrogen containing compound, such as a polyol, the catalyst, and the aldehyde scavenger blend according to the present disclosure. In some embodiments, the A-side reactant and/or B-side reactant may also optionally contain other auxiliary components such as those described above.

The polyurethane materials produced may be used in a variety of applications, such as, a precoat; a backing material for carpet; building composites; insulation; spray foam insulation; applications requiring use of impingement mix spray guns; urethane/urea hybrid elastomers; vehicle interior and exterior parts such as bed liners, dashboards, door panels, and steering wheels; flexible foams (such as furniture foams and vehicle component foams); integral skin foams; rigid spray foams; rigid pour-in-place foams; coatings; adhesives; sealants; filament winding; and other polyurethane composite, foams, elastomers, resins, and reaction injection molding (RIM) applications.

In one particular embodiment, the polyurethane material used in enclosed spaces, for example as thermal insulation materials in residential and commercial buildings, for example insulation for pipes and refrigerators, in furniture construction, for example as decorative elements or as seat cushioning, and also in automobile interiors, for example as seat cushioning, steering wheels, dashboards, door cladding, carpet-backing foam, acoustic foam, for example roof linings, headrests, or control buttons.

The present disclosure will now be further described with reference to the following non-limiting examples.

### EXAMPLES

### Description of the Aldehyde Emission Test

Formaldehyde and acetaldehyde were determined by a microchamber test. The size of the chamber was 128 mL. The temperature of the chamber during the test was set at 65° C., and the relative humidity was set to 50%. The air replacement rate was 3.0 liters per hour. The exhaust air stream containing volatile aldehydes from the polyurethane was passed through a cartridge containing 2,4-diuitrophenylhydrazine-coated silica and the cartridge was then eluted with a mixture of acetonitrile and water. The concentration of formaldehyde of the eluant was determined by means of HPLC. The detection limit for formaldehyde emissions for this setup was 5.1 ugm⁻²h⁻¹.

### Examples 1-3. Polyurethane Foam

Several polyurethane foams were produced from the following components.
Polyol A (NJ-360N): Polyetherol with OH number 28 mgKOH/g, purchased from NingWu New Material Development Corporation;
Polyol B (KONIX KE-880S): Polyetherol with OH number 20 mgKOH/g, purchased from KPX chemical;
DEOA: diethanolamine;
TEPA: Tetraethylene pentamine
HHEU: N-2(Hydroxyethyl)ethylene urea
Tegostab®B8738 LF2: foam stabilizer;
Jeffcat®ZF-10 tertiary amine catalyst;
Jeffcat®DPA tertiary amine catalyst;
Isocyanate: TM (TDI/Polymeric MDI=80/20)

Examples 1A-1D through 3A-3D were produced with the Isocyanate ™ being provided as the A-side reactant. The B-side reactants for Examples 1A-1D through 3A-3D are shown below in Tables 1, 4 and 7. All values listed in Table 1, 4 and 7 refer to parts by weight. The A-side and B-side reactants were mixed in the proportion (by weight) of A:B=43:100 and at an index of 1.05 and stirred in a polyethylene container. The polyurethane formulation was rapidly poured into polyethylene bag, a foaming reaction was allowed to proceed with the resulting foam being allowed to free rise. The resulting foam was then cured for a minimum of 15 minutes at room temperature. The foam samples were stored at room temperature (25±2° C.)/50% RH for 0-90 days and then subjected to the microchamber test. The results are provided in Tables 2, 3, 5, 6, 8 and 9.

TABLE 1
Foam formulation for Comparative Examples 1A-1D

| Component | Amount (pbw) |
|---|---|
| NJ-360N | 100 |
| KONIX KE-880s | 42.8 |
| DEOA | 1.43 |
| Tegostab ®8738 LF2 | 1 |
| Jeffcat ®ZF-10 | 0.21 |
| Jeffcat ®DPA | 0.91 |
| Water | 5 |
| TEPA | 0.14 |
| Barbituric acid | 0.14 |
| Isocyanate index | 105 |

TABLE 2
Aldehyde Scavenger content (expressed
as ppm based on total polyol content)

| | | | | Reduction in |
|---|---|---|---|---|
| | Storage | Aldehyde Scavenger content (ppm) | | formaldehyde |
| Sample | time (day) | TEPA | Barbituric acid | content (%) |
| 1A | 0 | 1400 | 1400 | 90.6 |
| 1B | 14 | 1400 | 1400 | 93.4 |
| 1C | 30 | 1400 | 1400 | 93.4 |
| 1D | 90 | 1400 | 1400 | 75.5 |

TABLE 3

| Sample | Acetaldehyde reduction (%) |
|---|---|
| 1A | (86.8) |
| 1B | (105.7) |
| 1C | (106.3) |
| 1D | (100.7) |

TABLE 4
Foam formulation for Comparative Examples 2A-2D

| Component | Amount (pbw) |
|---|---|
| NJ-360N | 100 |
| KONIX KE-880s | 42.8 |
| DEOA | 1.43 |
| Tegostab ®8738 LF2 | 1 |
| Jeffcat ®ZF-10 | 0.21 |
| Jeffcat ®DPA | 0.91 |
| Water | 5 |
| HEEU | 0.64 |
| Isocyanate index | 105 |

TABLE 5
Aldehyde Scavenger content (expressed
as ppm based on total polyol content)

| | | Aldehyde Scavenger content | Reduction in |
|---|---|---|---|
| | Storage | (ppm) | formaldehyde |
| Sample | time (day) | HEEU | content(%) |
| 2A | 0 | 6400 | 18.2 |
| 2B | 14 | 6400 | 29.3 |
| 2C | 30 | 6400 | 18.7 |
| 2D | 90 | 6400 | (13.7) |

TABLE 6

| Sample | Acetaldehyde reduction(%) |
|---|---|
| 2A | 33.9 |
| 2B | (8.4) |
| 2C | (34.3) |
| 2D | 14.6 |

TABLE 7
Foam Formulations For Inventive Examples 3A-3D

| Component | Amount (pbw) |
|---|---|
| NJ-360N | 100 |
| KONIX KE-880s | 42.8 |
| DEOA | 1.43 |
| Tegostab ®8738 LF2 | 1 |
| Jeffcat ®ZF-10 | 0.21 |
| Jeffcat ®DPA | 0.91 |
| Water | 5 |
| TEPA | 0.05 |
| Barbituric acid | 0.05 |
| HEEU | 0.71 |
| Isocyanate index | 105 |

TABLE 8
Aldehyde Scavenger content (expressed
as ppm based on total polyol content)

| | Storage | | | | Reduction in |
|---|---|---|---|---|---|
| | time | Aldehyde Scavenger content (ppm) | | | formaldehyde |
| Sample | (day) | TEPA | Barbituric acid | HEEU | content(%) |
| 3A | 0 | 500 | 500 | 7100 | 58.4 |
| 3B | 14 | 500 | 500 | 7100 | 67.9 |
| 3C | 30 | 500 | 500 | 7100 | 84.3 |
| 3D | 90 | 500 | 500 | 7100 | 83.3 |

TABLE 9

| Sample | Acetaldehyde reduction(%) |
|---|---|
| 3A | 60.9 |
| 3B | 64.3 |
| 3C | 73.0 |
| 3D | 77.8 |

As can be seen from the above Examples, when barbituric acid and an amine were used as aldehyde scavengers, the resulting foam exhibited increased acetaldehyde emission after 90 days storage. The use of HEEU alone as an aldehyde scavenger provided low formaldehyde and acetaldehyde control in the resulting foam. However, all three of these aldehyde scavengers in combination (as shown in Examples 3A-3D) were able to significantly control both the formaldehyde and acetaldehyde emission from the resulting foam for at least 90 days storage.

1. An isocyanate reactive composition comprising: (A) an aldehyde scavenger blend comprising: (i) a cyclic urea substituted with at least one isocyanate reactive group; (ii) a compound of the formula (I) 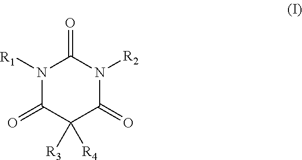
where X is O, S, or NHR₅ and R₁, R₂, R₃, R₄ and R₅ are individually selected from hydrogen, or an unsubstituted or substituted alkyl, alkenyl, aryl, alkylaryl, or alkoxy group subject to the proviso that at least one of R₃ and R₄ is hydrogen; and (iii) an amine compound selected from ammonia, a primary amine, and a mixture thereof; (B) an active hydrogen-containing compound; and (C) a catalyst.

2. The isocyanate reactive composition of claim 1, wherein the cyclic urea substituted with at least one isocyanate reactive group comprises a compound having the formula (II) 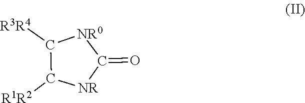
where R, R⁰, R¹, R², R³, and R⁴ are independently —H, —OH, -R⁵OH, —NH or —COOH, and R⁵ is a C₁-C₄ alkyl group, with the proviso that at least one of R or R⁰ is —H, and further with the proviso that: at least one of R, R⁰, R¹, R², R³, and R⁴ is —OH, —COOH, -R⁵OH, or —NH; or R¹R² or R³R⁴ are NH₂.

3. The isocyanate reactive composition of claim 2, wherein the compound of formula (II) is selected from 4,5-dihydroxy-2-imidazolidinone, 4,5-dimethoxy-2-imidazolidinone, 4-hydroxyethyl ethylene urea, 4-hydroxy-5-methyl propylene urea, 4-methoxy-5-methyl propylene urea, 4-hydroxy-5,5-dimethyl propylene urea, and 1-(2-hydroxyethyl)-2-imidazolidinone.

4. The isocyanate reactive composition of claim 1, wherein the compound of formula (I) is selected from barbituric acid, thiobarbituric acid, 1,3,5-trimethylbarbituric acid, 1-phenyl-5-benzylbarbituric acid, 1-benzyl-5-phenylbarbituric acid, 1,3-dimethylbarbituric acid, 1,3-dimethyl-5-phenylbarbituric acid, 1-cyclohexyl-5-ethylbarbituric acid, 5-laurylbarbituric acid, 5-butylbarbituric acid, 5-allylbarbituric acid, 5-hydroxy-5-butylbarbituric acid, 5-phenylthiobarbituric acid, 1,3-dimethylthiobarbituric acid, 5,5-dibromobarbituric acid, trichlorobarbituric acid, 5-nitrobarbituric acid, 5-aminobarbituric acid, 5-hydroxybarbituric acid and 5,5-dihydroxybarbituric acid.

5. The isocyanate reactive composition of claim 1, wherein the amine compound comprises a compound having the formula (IV) 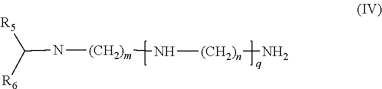
where R₅ and R₆ are individually selected from hydrogen, or an unsubstituted or substituted alkyl, alkenyl, aryl, alkylaryl, or alkoxy group, m is 2 or 3, n is 2, and q is 0-3.

6. The isocyanate reactive composition of claim 1, wherein the active hydrogen-containing compound is selected from a polyalkylene ether polyol, a polyester polyol, a biorenewable polyol, a polymer polyol, a non-flammable polyol, and a mixture thereof.

7. The isocyanate reactive composition of claim 1, wherein the catalyst comprises an amine catalyst.

8. The isocyanate reactive composition of claim 1, further comprising a blowing agent.

9. A polyurethane formulation comprising the isocyanate reactive composition according to claim 1 and a compound containing an isocyanate functional group.

10. The polyurethane formulation according to claim 9, further comprising a blowing agent and/or a non-amine catalyst.

11. The polyurethane formulation according to claim 10, further comprising one or more auxiliary components.

12. A method for producing a polyurethane material comprising contacting a compound containing an isocyanate functional group and, optionally, one or more auxiliary components with an isocyanate reactive composition comprising: (A) an aldehyde scavenger blend comprising: (i) a cyclic urea substituted with at least one isocyanate reactive group; (ii) a compound of the formula (I) 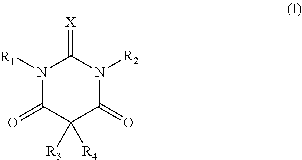
where X is O, S, or NHR₅ and R₁, R₂, R₃, R₄ and R₅ are individually selected from hydrogen, or an unsubstituted or substituted alkyl, alkenyl, aryl, alkylaryl, or alkoxy group subject to the proviso that at least one of R₃ and R₄ is hydrogen; and (iii) an amine compound selected from ammonia, a primary amine, and a mixture thereof; (B) an active hydrogen-containing compound; and (C) a catalyst.

13. A polyurethane material produced according to the method of claim 12.

14. The polyurethane material according to claim 13, wherein the polyurethane material is a rigid foam or a flexible foam.

15. The polyurethane material according to claim 14, wherein the polyurethane material exhibits a reduced level of emission of an aldehyde for an extended period of time.

16. The polyurethane material according to claim 15, wherein the extended period of time is at least 3 months.

17. The polyurethane material according to claim 16, wherein the polyurethane material is a precoat, a backing material for carpet, a building composite, insulation, a spray foam insulation, a urethane/urea hybrid elastomers; in vehicle interior and exterior parts, a flexible foam, an integral skin foam, a rigid spray foam, a rigid pour-in-place foam; a coating; an adhesive, a sealant, or a filament winding.

18. An insulation material comprising the polyurethane material of claim 13.

19. A seat cushion comprising the polyurethane material of claim 13.

20. A vehicle interior or exterior part comprising the polyurethane material of claim 13.
